(19) United States
(12) Patent Application Publication
(10) Pub. No.: US 2006/0135012 A1
(43) Pub. Date: Jun. 22, 2006

(54) Wiper/tack cloth with anti-static properties for painting operation and method of manufacture thereof

(76) Inventors: Martin E. Laker, West Bloomfield, MI (US); Martin Kaufmann, Beverly Hills, MI (US)

Correspondence Address: IPSG, P.C., P.O. BOX 700640, SAN JOSE, CA, 95170-0640, US

(21) Appl. No.: 10/543,184

(22) PCT Filed: Jun. 12, 2003
(86) PCT No.: PCT/US03/18698

§ 371 Date: Jul. 22, 2005

Related U.S. Application Data
(60) Provisional application No. 60/446,321, filed on Feb. 6, 2003.

(51) Int. Cl. B32B 27/04; D04B 21/00; B29C 35/08; B28B 1/00

(52) U.S. Cl. 442/110; 442/304; 264/494; 264/678

(57) ABSTRACT

A wiper/tack cloth used in painting operations being a knitted synthetic filament forming a fabric with non-lint producing edges. The wiper/tack cloth is impregnated in a chemical bath, squeezed and cured in an oven. The dried, impregnated substrate is cut to a desired size. A method of preparing the wiper/tack cloth is disclosed.

### BACKGROUND OF THE INVENTION

1. Field of the Invention

The invention relates to wiping cloths and more particularly to wiping cloths used in the painting industry where static electric charges and dust and dirt particulates are a problem.

2. Description of Related Art

In the automotive industry, and in many other applications where paint is sprayed on a metal or plastic surface, the condition of the surface is very important to obtain a smooth, even paint film on the surface. In particular, static electric charges and dirt and dust particulates on the surface are deleterious to the deposition of the paint.

Efforts have been directed to preparation of the surface prior to spraying the paint on the surface. Tack cloths based on resin have been used as well as dry wipers of fabric or paper. Woven and non-woven dry wipers have been used. Also, solvent cleaning of the surface has been used with pre-saturated wipers and lint free wipers which have been dipped in solvent.

In U.S. Pat. No. 3,658,578, Bennett discloses tack cloths made from paper or cotton fabric which are impregnated with amorphous polypropylene having a molecular weight in the range of 2,000 to 8,000 dissolved in an organic solvent. An emulsifying agent is added for aqueous use. The product is dried at ambient temperatures of 50°-100° F.

Ogata et al in U.S. Pat. No. 3,952,128 disclose an anti-static agent for hydrophobic fibers. The anti-static agent is a polyvinyl derivative having quaternary ammonium groups on its side chains. The counter ion is an anionic surfactant containing ethylene oxide units.

Diehl, in U.S. Pat. No. 3,958,059 discloses an anti-static fabric softener composition which has electrically conductive metal salts in quaternary compounds. Amide dispersion stabilizers are added. The composition is used in laundering procedures.

Murphy, in U.S. Pat. Nos. 3,962,100 and 4,025,444 discloses alkyl ammonium carbonates as fabric softeners and anti-static substances which are used in combination with laundry detergents.

In U.S. Pat. No. 4,075,375, Komatsu discloses a process for preparation of cleaning materials which has a fibrous substrate and an oiling composition adsorbed and impregnated in the fibrous substrate. The fibrous substrate is cellulose which may have up to 30% by weight synthetic fiber. The oiling composition is mineral oil and/or a synthetic lubricating oil, a surface active agent and a benzene carboxylic acid ester.

These approaches have not been satisfactory and the problem persists.

### BRIEF SUMMARY OF THE INVENTION

It is an object of the invention to provide a lint-free, anti-static treated wiper/tack cloth that captures and removes particulates and does not leave a static electric charge on a surface to be painted.

It is a further object to provide a method of manufacture of the wiper/tack cloth.

In accordance with the teachings of the present invention, there is disclosed a wiper/tack cloth particularly for use in painting operations. The cloth has a substrate formed by a knitted continuous polyester filament. The substrate is treated with an anti-static agent, such that the wiper/tack cloth is anti-static.

In further accordance with the teachings of the present invention, there is disclosed the method of making a lint-free anti-static wiper/tack cloth. A substrate is provided which is passed through a bath containing chemical agents. The substrate is squeezed to remove excess chemicals and then passed through an oven for curing the wiper/tack cloth. The cured cloth is cut into desired lengths such that the substrate becomes anti-static and additionally will capture dirt and dust particulates.

These and other objects of the present invention will become apparent from a reading of the following specification taken in conjunction with the enclosed drawings.

### BRIEF DESCRIPTION OF THE DRAWINGS

FIG. 1 is a perspective view showing a vehicle being wiped before being painted.

FIG. 2 is a perspective view of the wiper cloth showing the knitted filament.

FIG. 3 is an enlarged view of a corner of FIG. 2.

FIG. 4 is a view of a wiper cloth being cut by a hot wire.

FIG. 5 is a flow diagram showing the method of making the wiper cloth.

### DESCRIPTION OF THE PREFERRED EMBODIMENTS

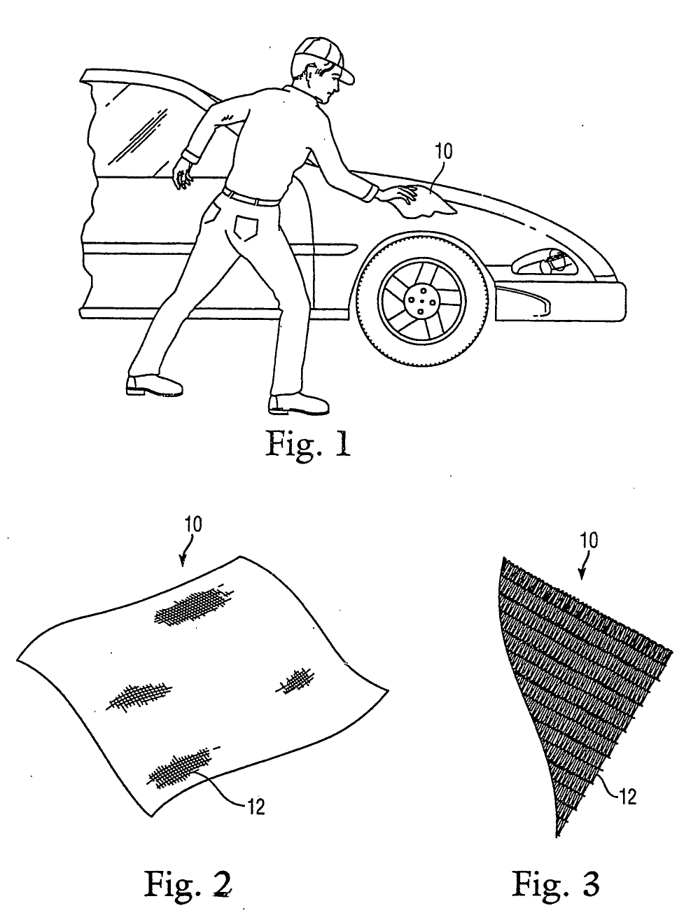

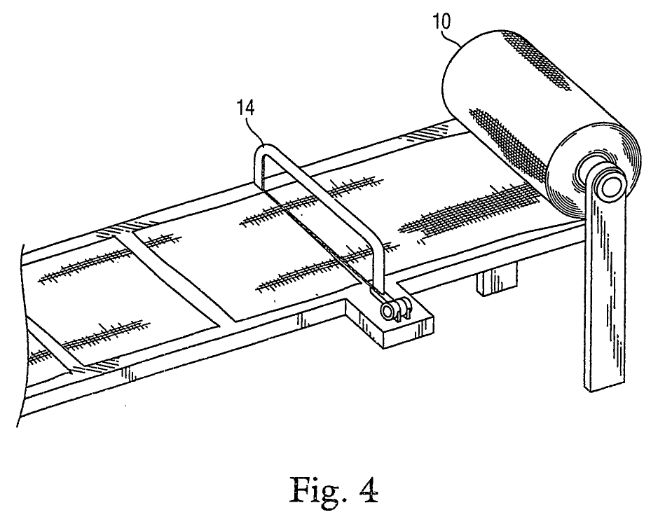

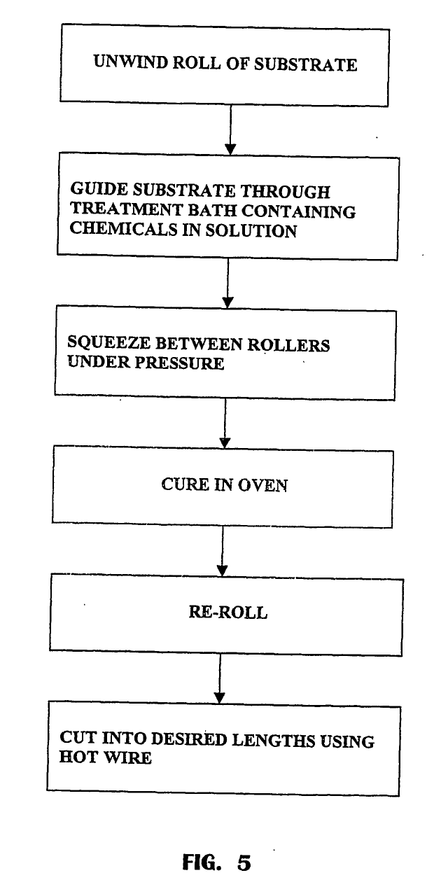

Referring to FIGS. 1-3, the surface of a vehicle or other object which is to be painted is wiped with a substrate treated with an anti-static agent so that the paint is deposited on the surface in a smooth, uniform coating. A substrate 10 is formed from a continuous synthetic filament. Polyester filaments have been found to be satisfactory and are preferred. Preferably, the substrate is woven, although non-woven material may be used. The non-woven material may generate lint as compared to woven material. The edges of the wiper cloth must be lint free. This can be accomplished by having a knitted edge and by cutting the substrate with a heated tool such as a hot wire (FIG. 4). The heated tool seals the edges of the synthetic filament.

The substrate 10 is impregnated with chemical agents to reduce the static electric properties of the substrate and to provide a dust and lint capturing agent. The treatment solution may comprise:

| Water | 40% to 75% |
|---|---|
| Isopropyl alcohol | 5% to 20% |
| Propylene glycol | 2% to 10% |
| Quaternary ammonium salt | 1% to 25% |
| Additives | <1% |

An example of an alkyl quaternary ammonium salt which has been formed to provide good anti-static properties is SRW 031 which is a product sold by Durable System, Inc., 3990 West Twelve Mile Road, Berkley, Mich. 48072. It is preferred that the salt be a chloride salt.

As shown in FIG. 5, the wiper/tack cloth is prepared by providing a roll of substrate approximately 740 yards long, and approximately 10.5 inches wide. It is unwound and guided through a bath containing the above-described treatment solution. After the bath, the substrate is squeezed between two rollers under high pressure to remove excess chemical solution. Pressure is indicated on a hydraulic gauge on the pump, which adds pressure to the cylinders that push the rollers together creating the pressure. The pump is set at approximately 400 PSI. Approximately 1,250 pounds of force is applied by each cylinder or 2,500 pounds of total force. After squeezing the substrate, it passes through an oven at a speed of about 40 feet per minute at a temperature range of 280° F. to 350° F. This process cures the product. The product then gets re-rolled and is taken to the cutting area. It is cut into lengths of approximately 18 inches with a hot wire, or other heated tool which cuts and seals the two cut edges to eliminate loose fibers. The length can vary based upon customer needs. The substrate usually shrinks to a width of approximately 9 inches during curing.

After curing, the substrate has a residual on the filament as follows:

| | |
|---|---|
| Traces of water | 0% to 4% |
| Traces of propylene glycol | 2% to 5% |
| Quaternary ammonium salt | 90% to 95% |

Automobile manufacturers have established test procedures and requirements for tack cloths. There is no industry-wide test procedure and each manufacturer has its own criteria. The applicant had an independent test organization test the present invention using the criteria of several automobile manufacturers. The results are as follows:

| | | |
|---|---|---|
| Test | Requirement | Results |

Manufacturer A

| | | | |
|---|---|---|---|
| 1. | Helmke Drum (particles/m2) | <20 | 6 |
| | 5 micron | | |
| 2. | Haden Tube Test | <2,000 | 0 |
| | (particles/m2) | | |
| 3. | Snag | <12 | 5 |
| 4. | Dirt Holding (g/m2) | ≧85 | 98.6 |
| 5. | Tack Transfer | ≦25 | 1.0 |

Manufacturer B

| | | | | |
|---|---|---|---|---|
| 1. | Readily Releasable | 300 | particle/m\hat{ }2 | 6 |
| 2. | Snag | 150 | | 24 |
| 3. | Tack Transfer | 15 | mg/m\hat{ }2 | 1.3 |
| 4. | Haden Tube | 5,500 | | 0 |
| 5. | Dirt Holding Capacity | 100 | g/m\hat{ }2 | 117.5 |
| 6. | Dirt Holding Capacity | 90 | g/m\hat{ }2 | 94.3 |
| | (6 hour exposure) | | | |
| 7. | Telegraphing (Tack Sanddrift) | 1 | | 1 |
| 8. | Telegraphing (tack, black) | 1 | | 1 |
| 9. | Stovepipe | 40 | | 17 |

Manufacturer C

| | | |
|---|---|---|
| Dirt Holding Capacity | >85% | 98.3% |

Thus, the present invention greatly exceeded the requirements for all three of the manufacturers. The data indicate that the tack cloth of the present invention is very versatile and efficient. A tack cloth which passes the above tests is defined herein as being “lint-free”.

The wiper/tack cloth of the present invention has the following features and advantages:
Reduces static charge.
Removes dirt and dust particulate and reduces paint defects.
Eliminates marring caused by resin transfer (since there is no resin).
Product is not as pressure sensitive when used by operator.
Reduces operator error caused by applying too much pressure when wiping.
More user friendly to operator drag when wiping.
All edges are either knitted or sealed which reduces loose fibers.

Has extended shelf life when opened as compared to previous so-called pre-saturated wipers.
Neutralizes negative electrostatic charges that make paint impossible to adhere to plastic or metal surfaces.
Product does not release any volatile organic compounds (voc).

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. In a wiper/tack cloth particularly for use in painting operations, the improvement comprising a substrate formed by a knitted continuous polyester filament, the substrate being treated with an anti-static agent, such that the wiper/tack cloth is anti-static and lint-free.

2. The improvement of claim 1, wherein the substrate is also treated with a dirt-encapsulating agent, such that the wiper/tack cloth captures and removes dirt and dust particulates.

3. The improvement of claim 1, wherein that the substrate has knitted edges to eliminate lint.

4. The improvement of claim 1, wherein the substrate has heated seal edges to eliminate lint.

5. The improvement of claim 1, wherein the anti-static agent comprises a quaternary ammonium salt.

6. The improvement of claim 5, wherein the anti-static agent comprises an alkyl quaternary ammonium salt.

7. The improvement of claim 1, wherein the salt is a chloride salt.

8. The method of making a lint-free anti-static wiper/tack cloth, comprising the steps of providing a substrate, passing the substrate through a bath containing chemical agents, squeezing the substrate to remove excess chemicals, passing the substrate through an oven for curing the wiper/tack cloth, and cutting the substrate into desired lengths such that the substrate becomes anti-static and additionally will capture dirt and dust particulates.

9. The method of claim 8, wherein the substrate comprises a roll of substrate which is unwound and passed through the bath.

10. The method of claim 9, wherein the substrate passes through the bath at approximately 40 feet per minute and at a temperature between approximately 280° F. to 350° F.

11. The method of claim 8, wherein the substrate comprises a knitted continuous synthetic filament.

12. The method of claim 11, wherein the synthetic filament is a polyester filament.

13. The method of claim 8, wherein the wiper/tack cloth is cut by a heated tool which cuts and seals the wiper/tack cloth to eliminate loose fibers.

14. The method of claim 8, wherein the bath is provided with an anti-static chemical agent comprising a quaternary ammonium salt.

15. The method of claim 14, wherein the anti-static chemical agent is an alkyl quaternary ammonium salt.

16. An anti-static, dust particulate-capturing wiper/tack cloth made in accordance with the method of claim 14.

17. The dirt and dust particulate-capturing wiper/tack cloth of claim 16 which is intended, primarily, for use in painting operations.

18. The method of claim 8, wherein the substrate is squeezed between two rollers wherein approximately 2,500 pounds of total force is applied to the rollers.

19. The method of claim 8, wherein the substrate is formed from a woven material.

20. The method of claim 8, wherein the substrate is formed from a non-woven material.
